(19) United States
(12) Patent Application Publication
(10) Pub. No.: US 2007/0059399 A1
(43) Pub. Date: Mar. 15, 2007

(54) Production of protein composition from a dairy stream and its use as an ingredient in the manufacture of a cheese

(76) Inventors: Peter Gilbert Wiles, Palmerston North (NZ); Peter Dudley Elston, Palmerston North (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/567,918

(22) PCT Filed: Aug. 6, 2004
(86) PCT No.: PCT/NZ04/00176

§ 371 Date: Nov. 13, 2006

(30) Foreign Application Priority Data
Aug. 7, 2003 (NZ) 527434

(51) Int. Cl. A23C 9/12

(52) U.S. Cl. 426/36

(57) ABSTRACT

The invention described is a process for manufacturing a dairy ingredient particularly suited for use in cheese manufacture. The process involves treating a dairy stream under conditions to form a protein concentrate and serum. The stream may optionally be split and different conditions/reactants used in each separate stream to modify the entrained proteins before the separate streams are recombined. The protein concentrate is solubilised before being recombined with the serum. The mono-di-valent cation content of the protein concentrate may be adjusted as the protein concentrate is solubilised. The ingredient produced can be used in the manufacture of cheese products.

### BACKGROUND TO THE INVENTION

1. Field of the Invention

The invention relates to a process for producing a dairy ingredient. More particularly the invention relates to the manufacture of a protein composition from a dairy stream and its use in the manufacture of cheese.

2. Description of the Related Art

Protein concentrates, in either granular or powder form, and milk retentate powders are widely used as ingredients in the food industry and in particular in cheese and processed cheese manufacture. These ingredients can be more generally denoted as proteinates as they typically have>50% protein, often>70% protein and occasionally>80% protein, when expressed on a moisture and fat-free basis.

U.S. Pat. No. 6,183,804 and U.S. Pat. No. 6,183,805, teach a method of preparing a milk protein concentrate ingredient as a powder using ultrafiltration and diafiltration followed by concentration and drying. This process provides limited means to manipulate the mineral content of the product and negligible means to alter independently the properties of the casein and whey proteins. These ingredients are often known as MPCs. Although the use of such protein concentrates is generally useful in the manufacture of processed cheese, there are some limitations. High protein concentrate ingredients are disproportionately more expensive to manufacture by ultrafiltration because there is a disproportionate increase in the number of ultrafiltration or diafiltration stages required as the protein content is increased. Lower protein concentration ingredients have higher lactose and mineral concentrations. Excessive lactose in the final (cheese) products can result in browning and flavour impairment, opportunity for undesired secondary fermentation and lactose crystallization due to the limited amount of water present. Consequently, most cheese and processed cheese manufacturers prefer protein concentrate ingredients having upwards of 70% protein.

Proteinates can be enhanced in their functional properties e.g. solubility, and cheese making properties, by the manipulation of the monovalent and divalent cations. There are known methods for manipulating cations in protein concentrates, for example by pH adjustment or salt incorporation during ultrafiltration (U.S. Pat. No. 5,356,639). A process giving much wider scope for the manipulation and control of cations and protein content is taught in WO 01/41579 where a proteinate ingredient may be prepared using a combination of ultrafiltration, diafiltration and cation exchange using a cationic ion exchange resin medium. This process has the limitation that the exchange of monovalent cations to replace divalent cations in the treated stream is subject to stoichiometric control i.e. two moles of monovalent ions replace each mole of divalent ions. As a result, high levels of sodium or potassium ions in the product can impair the flavour and raise food labeling issues, especially for use in low salt diet products.

U.S. Pat. No. 4,202,907 teaches another approach to the preparation of proteinates. Skim milk is initially ion exchanged to replace a proportion of the calcium ions with sodium ions and then renneted to modify the properties of the protein. The treated solution is then converted to a dry proteinate ingredient by concentrating and drying. This process also suffers from the above limitation of stoichiometric substitution of the mono and divalent cations. In an alternative embodiment, Poarch describes a process of producing a proteinate (of lower cost) by solubilising casein in a basic monovalent salt (NaOH) using whey as a solvent and then treating the solution with rennet. The treated solution is then ion exchanged to remove calcium, concentrated and dried. This process offers scope to manipulate the cation concentrations stoichiometrically and offers some scope to manipulate the proportions of protein and lactose, or the casein to whey protein+lactose concentrations. This process does not teach the means to escape from the limitations of the stoichiometric substitution of the ions, nor does it teach a means of independently modifying the properties of the casein and whey proteins.

Co-precipitate is another proteinate, which has long been known. The process generally involves heat treating skim milk 85-95° C. for 1-20 minutes and treatment with CaCl₂ and/or acid to precipitate the protein. The recovered protein concentrate may be solubilised by treatment with NaOH and dried (Dairy processing handbook, 2^{nd} revised edn. Tetra Pak Processing Systems, Lund, Sweden, 2003 pp. 414-415). A variety of mono-divalent cation ratios is possible by varying the process. Because of the heat treatment given to the proteins, little or no control is possible in the art for the separate manipulation of the properties of the casein and whey proteins.

It is an object of the invention to go some way towards overcoming these disadvantages or at least to offer the public a useful choice.

### SUMMARY OF THE INVENTION

Accordingly, one aspect of the invention is a process for producing a protein composition from a dairy stream which comprises the steps:
a) subjecting the dairy stream to conditions which cause the formation of a protein concentrate and serum,
b) separating the protein concentrate and the serum,
c) solubilising the separated protein concentrate in an aqueous solution,

d) combining the solubilised protein concentrate with the separated serum to form the protein composition, and
e) concentrating the protein composition formed in step d).

In one embodiment the conditions in step a) comprise adjusting the pH of the dairy stream to a range of 4.5 to 4.8, followed by heating to form a protein concentrate and serum.

In another embodiment the conditions in step a) comprise adding an enzyme capable of converting kappa-casein to para-kappa-casein to the dairy stream followed by heating to form a protein concentrate and serum.

In a further embodiment the step a) comprises dividing the dairy stream aqueous medium containing the milk protein into two portions,
adjusting the pH of one portion to a range of 4.5 to 4.8,
adding an enzyme capable of converting kappa-casein to para-kappa-casein to the other portion, and
combining the two portions and heating the combined stream to form a protein concentrate and serum.

In one embodiment the dairy stream is skim milk.

In another embodiment the dairy stream is pasteurised.

In another embodiment the dairy stream undergoes a membrane concentration step.

In another embodiment the membrane concentration step is an ultrafiltration step.

In one embodiment the pH is adjusted in step a) by the addition of an acid, preferably a food approved acid, more preferably hydrochloric or sulphuric acids.

In one embodiment when the dairy stream contains lactose, the pH is adjusted by the addition of a starter culture to ferment a portion of the lactose to acid, most commonly lactic acid.

In one embodiment the starter culture is any food approved bacteria culture capable of fermenting lactose to form acid.

In one embodiment the bacterial culture is of a strain of the genus lactobacillus.

In one embodiment the pH is adjusted to about 4.6.

In an embodiment where the dairy stream is divided, the other portion of the dairy stream is reacted with the kappa casein converting enzyme at a temperature below about 15° C., preferably at less than 10° C.

In another embodiment the kappa casein converting enzyme is chymosin.

In another embodiment the kappa casein converting enzyme is rennet, preferably derived from either animal or microbial sources.

In another embodiment the protein concentrate and serum are formed by heating to a temperature of between about 25° C. and 70° C., more preferably between 30° C. and 55° C. and most preferably between 40° C. and 50° C.

In one embodiment the heating is carried out for a holding time of from 1 to 600 seconds, preferably 5 to 200 seconds, more preferably 10 to 50 seconds.

In another embodiment the protein concentrate separated in step b) is washed with water.

In another embodiment the protein concentrate separated in step b) is milled.

In another embodiment in step c) the protein concentrate is dissolved in an alkaline solution.

In another embodiment the alkaline solution contains cations including sodium, potassium, calcium, magnesium or a mixture thereof.

In another embodiment the protein levels of the serum separated in step b) are adjusted by addition, removal or modification of the proteins.

In another embodiment the serum separated in step b) is concentrated before being combined with the solubilised protein concentrate in step d).

In another embodiment the serum separated in step b) is further separated into a protein rich stream and a lactose rich stream.

In another embodiment in step d), the concentrated protein solution is mixed with all or part of the protein rich serum stream and all or part of the lactose rich stream to form the protein composition.

In another embodiment fat, oil or cream is added to the protein composition formed in step d).

In another embodiment the protein composition is homogenised.

In another embodiment the protein composition is dried.

In another embodiment the protein composition is used in the manufacture of a cheese.

The invention also includes a protein composition prepared by the process defined above.

In another embodiment the invention is a cheese prepared using the composition defined above.

Another embodiment of the invention is a milk proteinate composition containing both para-kappa-casein and whey protein, which, when concentrated, does not form a gel.

In one embodiment the milk proteinate composition has a calcium concentration of from 2,700 mg/kg to 15,000 mg/kg and a sodium concentration of from 11,000 mg/kg to 1,300 mg/kg.

In another embodiment the milk proteinate composition is a powder.

Another embodiment of the invention is a cheese prepared using the proteinate composition defined above.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

FIG. 1 is a flow diagram showing the method according to one embodiment of the invention.

### DETAILED DESCRIPTION OF THE PREFERRED EMBODIMENTS

The expression “dairy stream” used herein may include any liquid source of milk protein. Although the most common type of dairy stream to be used in this invention is skim milk, dairy streams could include milk protein concentrates (MPCs) as concentrates or re-dissolved or suspended forms.

“Skim milk” herein refers to milk with a low fat content, preferably below 1% w/w. Such milk is also referred to as “low fat milk” in the art.

The expression “serum” used herein means the supernatant remaining after the precipitation of casein. Serum includes the supernatant liquid and the proteins dissolved or suspended in it.

Detailed Description of the Drawing

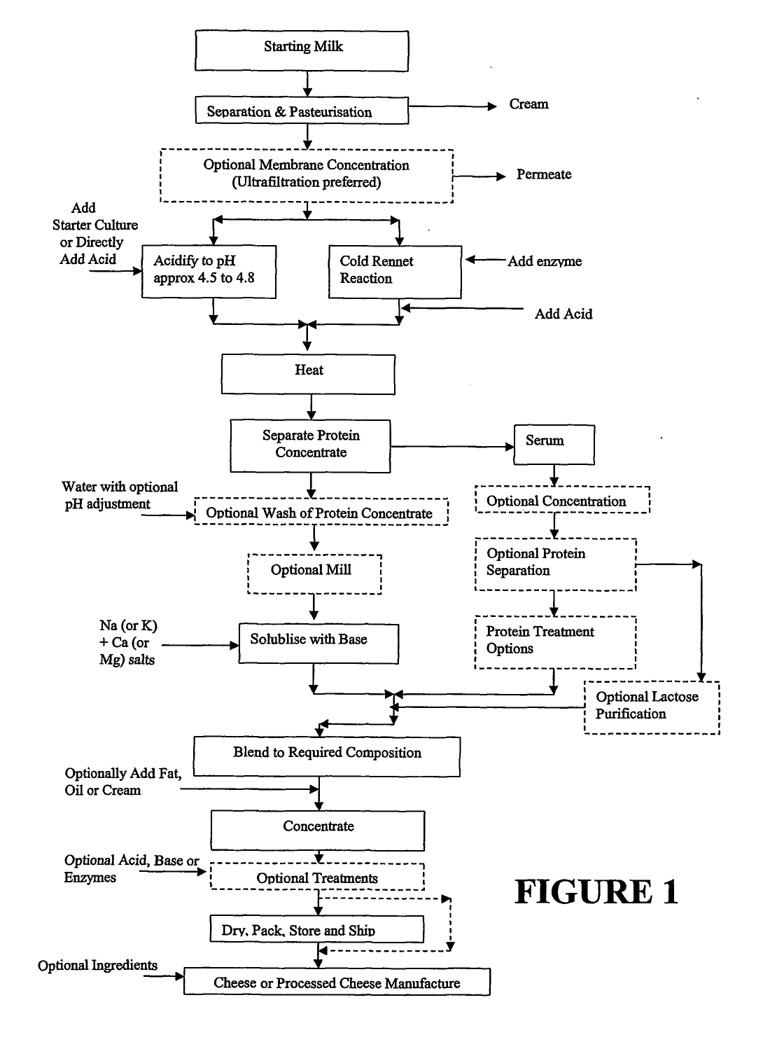

The following description is of the ways of carrying out the invention illustrated in FIG. 1.

Skim milk may be separated from whole milk, or reconstituted whole milk or may be reconstituted from a skim milk powder. Preferably the slim milk is pasteurized.

Optionally, the skim milk is concentrated using a membrane technique to enrich the retentate in protein. A preferred membrane technique is ultrafiltration. The protein concentrate may constitute between 20% and 80% the volume of the original skim milk.

Optionally the skim milk or protein concentrate is treated with an enzyme that forms para kappa-casein from kappa-casein. A preferred temperature for the enzyme reactio'n is <15° C.

In the process shown in FIG. 1, the skim milk or protein concentrate (dairy) stream is divided into two portions which are treated under different conditions. The two portions are then recombined and heated to form a protein concentrate as described below.

In an alternative, not shown, the dairy stream is not divided, but treated by either the addition of a starter culture or an acid, followed by heating; or alternatively, by the addition of an enzyme, followed by heating.

In the embodiment shown, in the left portion the skim milk or protein concentrate is dosed with acid to attain a pH of about 4.6, such that on heating, the insoluble protein rapidly precipitates. The precipitated protein and serum are in a state that enables ready separation. Preferred methods of separation are inclined screens and decanters or combinations of both.

To the right portion, enzyme is added. Chymosin (rennet) is a preferred enzyme. The acidity may be provided by mixing with a dilute mineral acid such as sulphuric or hydrochloric acid, or alternatively, the acid may be generated by fermenting lactose present in solution upon the addition of a suitable bacterial starter culture.

The left and right stream portions are then recombined. They are heated to a preferred temperature range such as, for example, between 25° C. and 70° C. for a holding time of between about 1 and 600, preferably 5-200 seconds. Any range within these limits may be used. Most preferred ranges are temperatures between 30 and 55° C. and times between 10 and 50 seconds.

Optionally the recovered insoluble protein concentrate may be washed with water, or

In a preferred embodiment, the insoluble protein is milled finely to a small relatively uniform particle size. More preferably, curd milling is conducted using a colloid mill.

The insoluble protein concentrate is then dissolved in a solution containing a mixture of mono-valent and divalent cations. Preferred mono-valent cations are sodium or potassium ions and preferred divalent cations are calcium or magnesium ions, and the preferred delivery vehicle for the respective ions are their hydroxides or oxides. The ratio of the application of the mono and divalent cations is the desired ratio of the ion pair in the final product (ingredient). A preferred embodiment is in a range 20% to 90% mono-valent cations with the balance being divalent cations (80% to 10%).

In an alternative embodiment, the solubilised protein concentrate may be treated with an enzyme. A preferred enzyme is one that converts kappa-casein to para-kappa-casein. The enzyme may be deactivated after sufficient treatment by the application of heat

The serum contains whey proteins, lactose and a variety of salts and minor components.

The serum may be treated by a wide variety of processes to purify, enhance or modify its properties. Preferred techniques that may be used, but not limited to, are ultrafiltration, electrodialysis, ion exchange and affinity chromatography, mineral and/or pH adjustment, heat treatment, shear and concentration.

In another aspect, the serum may be divided into two or more sub-streams. One stream may be rich in protein and another may be rich in lactose. Each of the streams may be treated by the preferred techniques previously identified.

The solubilised protein concentrate stream is then combined with all or part of the treated protein rich stream and all or part of the lactose rich stream derived from the serum. In a preferred embodiment, the blending ratios are determined by the desired ratios of casein protein, whey protein and lactose in the final product. In a preferred embodiment, the desired blend has a protein content (expressed on a dry basis) or at least 40% and less than 90%.

Optionally edible oil, fat, milk fat, cream or high fat cream may be added to the blended stream.

Optionally, the combined stream may be homogenized to attain a fine uniform dispersion of the fat bearing phase in the aqueous phase.

Preferably the mixture is concentrate. Preferred concentration equipment is multi-stage evaporation.

Optionally, ingredients may be added after concentration and prior to drying.

Optionally, prior to drying, the pH and/or temperature may be adjusted to optimize the solution viscosity.

After concentration, the product is dried. Preferred drying equipment is spray drying. Preferably the moisture in the product leaving the drier is >0.5% and <10% by weight.

After pacling the product may be stored and used when and where is desired as an ingredient.

The ingredient being rich in active milk protein, and highly nutritious, is particularly useful in the production of cheese-like products and more preferably in the manufacture of processed cheese-like products. The properties of the ingredient can be tailored for these applications beyond what can be achieved efficiently by other processes known in the art.

In a preferred embodiment, the ingredient may be used in the production of processed cheese by the addition of a potable solvent (water is preferred), milk fat, salt, melting salts and flavouring agents. The mixture is heated with shear (cooked) and once a molten homogeneous mass is formed, packed off into processed cheese or processed cheese-like products.

The invention has application in producing protein compositions useful as ingredients for manufacturing further ingredients or consumer products. The levels of components are able to be adjusted as desired during the production of the composition, and the levels of these components can be “carried through” to the final products.

### EXAMPLES

### Example 1

### Preparation of Ingredient Samples

Curd 1

Casein protein from 3000 L of skim milk was separated from the serum at pH 4.6 by acidifying the skim milk with dilute sulphuric acid and the excess serum was drained off to produce 180 kg of wet milk protein. The wet protein was not washed. This was denoted ‘protein concentrate 1’.

Curd 2

1500 L of skim milk at 10° C., was reacted with rennet (“Australian Double Strength”) using 1 part rennet, to 10,000 skim milk). The following day, the casein protein was separated from the serum at pH 4.6 by acidifying with dilute sulphuric acid. The excess serum was drained off to produce 90 kg wet milk protein. The wet protein was not washed. This was denoted ‘protein concentrate 2’.

TABLE 1
Composition of Ingredients

| | Skim Milk | WPC (Alacen 392 ™) |
|---|---|---|
| Protein | 3.93 | |
| (TN* × 6.38) % | | |
| True Protein % | | 75.9 |
| Moisture % | 90.56 | 4.2 |
| Ash % | | 3.44 |
| Fat % | | 5.33 |
| Lactose % | | 7.18 |
| Ca (mg/kg) | 1310 | |

*In this and the following tables TN = total nitrogen

### Example 2

### Preparation of Whey Protein Solutions

17.2 kg of a whey protein concentrate (WPC) (sold as Alacen 392™, Fonterra Cooperative Group Limited, Auckland) was dissolved in 260 kg demineralised water to make a 6% WPC solution (with native (undenatured) whey protein). One half the whey protein solution was heat treated by heating to 151° C. for 4 minutes by circulating through an evaporator pre-heater holding tube to denature the proteins.

### Example 3

### Preparation of Soluble Mineralised Proteinate Solutions

Run 1

30 kg of protein concentrate 1 from example 1 was mixed with 70 L of the native whey protein solution from example 2. The mixture was treated with sodium hydroxide (0.2 kg NaOH dissolved in approximately 100 L water) at 65° C. with stirring. Once the pH of the mixture was stable at 6.8, the solution was dried to yield a powdered proteinate ingredient

Run 2

30 kg of protein concentrate 1 from example 1 was mixed with 70 L of the native whey protein solution from example 2. The mixture was treated with calcium hydroxide (0.3 kg Ca(OH)₂ dispersered in approximately 100 L water) at 65° C. with stirring. Once the pH of the mixture was stable at 6.9, the solution was dried to yield a powdered proteinate ingredient

Run 3

30 kg of protein concentrate 2 from example 1 was mixed with 70 L denatured whey protein solution from example 2. The mixture was treated with sodium hydroxide (0.2 kg NaOH dissolved in approximately 100 L water) at 65° C. with stirring. Once the pH of the mixture was stable at 6.8, the solution was dried to yield a powdered proteinate ingredient

### Example 4

### Preparation of Dried Powders

The proteinate solution from each of Runs 1, 2 and 3 in Example 3 was spray dried using a single stage dryer with an inlet air of temperature 200° C. and a feed pressure to the nozzle of 20 MPa.

TABLE 2
Composition of Intermediate Protein Samples

| | Recovered wet protein | |
|---|---|---|
| | Protein concentrate 1 | Protein concentrate 2 |
| | (Acid pH 4.6) | (Rennet + Acid pH 4.6) |
| Moisture % | 52.2 | 55.4 |
| Fat % | 0.20 | 0.35 |
| Protein (TN × 6.38) % | 44.6 | 41.5 |
| Ash % | 1.40 | 1.37 |
| Ca (mg/kg) | 5,540 | 1,230 |

TABLE 3
Analysis of Proteinate Ingredient Sample Powders

| | | Protein | |
|---|---|---|---|
| | Protein | concentrate | Protein |
| | concentrate | 1 + | concentrate 2 + |
| | 1 + NaOH + | Ca(OH)₂ + | NaOH + |
| Powder | Native WP | Denatured WP | Denatured WP, |
| Protein | 88.6 | 85.5 | 84.3 |
| (TN × 6.38) % | | | |
| Casein % | 75.0 | 80.3 | 78.3 |
| Whey Protein % | 12.2 | 4.1 | 4.8 |
| WP/casein | 0.16 | 0.05 | 0.06 |
| Moisture % | 4.08 | 3.31 | 4.26 |
| Ash % | 4.29 | 4.96 | 5 |
| Fat % | 1.74 | 1.38 | 1.98 |
| Lactose % | 4.23 | 4.06 | 4.37 |
| Total* | 102.94 | 99.21 | 99.91 |
| Ca (mg/kg) | 2790 | 14900 | 7250 |
| K (mg/kg) | 2900 | 2520 | 2830 |
| Mg (mg/kg) | 333 | 335 | 366 |
| Na (mg/kg) | 10800 | 1330 | 9140 |
| P (mg/kg) | 6310 | 6560 | 6620 |

*Casein + whey protein + moisture + ash + fat + lactose

The proteinate ingredient powders in Table 3 were prepared with calcium concentrations ranging from at least 2790 to 14,900 mg/kg while having sodium concentrations ranging from at least 10,800 to 1330 mg/kg and having a range of protein treatments. A person skilled in the art would realise that a vast array of other proteinate ingredients could be prepared according to this invention by making slight changes to the above procedures or combining in varying proportions two or more solution streams before the concentration or drying stages.

### Example 5

### Preparation of Processed Cheese Spread

Formulation of Spread Samples

The three proteinate ingredient powders of Table 3 were used to make a processed cheese spread formulation and tested for their ability form an acceptable spread and to determine the texture. A control ingredient powder was also used as a reference. A control spread was prepared using a standard 70% milk protein concentrate [NPC70] (ALAPRO 4700™, Fonterra Cooperative Group Limited, Auckland) ingredient powder.

Protein Ingredient Composition

The proteinate ingredients used in the spreads had compositions shown in Table 3 and the composition of the NTC70 control is shown in Table 4.

TABLE 4
Ingredient composition

| Ingredient | ALAPRO 4700 ™ (Control) |
|---|---|
| Fat % | 0.96 |
| Protein % | 72.9 |
| Lactose % | 17.2 |
| Ash % | 7.54 |
| Moisture % | 3.81 |
| Na mg/kg | 210 |
| Ca mg/kg | 2010 |

Spread samples were prepared using the formulations in Table 5.

TABLE 5
Formulations of spreads

| | | | Protein | Protein |
|---|---|---|---|---|
| | | Protein | stream 1, | stream 2, |
| | Control | stream 1, | Ca(OH)₂, | NaOH, |
| | (ALAPRO | NaOH, | Denatured | Denatured |
| Ingredient | 4700 ™) | Native WP | WP | WP, |
| Soya oil (g) | 185.5 | 185.5 | 185.5 | 185.5 |
| Protein | 85.1 | 69.0 | 68.9 | 70.4 |
| ingredient (g) | | | | |
| Lactose (g) | 3.2 | 18.3 | 18.0 | 17.2 |
| TSC (g) | 13.28 | 15.23 | 14.79 | 14.73 |
| CA (g) | 3.35 | 1.40 | 1.84 | 1.90 |
| Salt (g) | 6.0 | 6.0 | 6.0 | 6.0 |
| Water (g) | 297.6 | 298.6 | 299.0 | 298.3 |
| (includes | | | | |
| allowance | | | | |
| of 11.0 g for | | | | |
| evaporation) | | | | |
| Total (g) | 594.03 | 594.03 | 594.03 | 594.03 |
| Moisture (%) | 51.2 | 51.45 | 51.35 | 51.35 |
| Measured pH | 5.72 | 5.78 | 5.77 | 5.77 |

TSC = tri-sodium citrate
CA = citric acid

Method of Spread Preparation

The spreads were prepared using a 2 L capacity Vorwerk Thermomix™ 21 blender-cooker (Vorwerk Australia Pty. Ltd., Granville, N.S.W., Australia) and the procedure described below.

The proteinate ingredient e.g. NPC70 (70% protein (dry basis)) was hydrated in a salt solution (113.28 g fri-sodium citrate (Jungbunzlauer GmbH, Perhofen, Austria), 3.35 g citric acid (Jungbunzlauer GmbH, Perhofen, Austria), 6.0 g sodium chloride (Pacific Salt, Christchurch, New Zealand) and 200 g water). The mixture was allowed to sit (to hydrate) overnight at 4° C.

Soya oil (AMCO™, Goodman Fielder, Auckland, New Zealand) was heated for 1 min at temperature set at 100 and speed set at 1 (this brought the temperature of the oil to 60° C.).

The hydrated proteinate ingredient (MPC70), lactose and the remaining water (97.6 g) were added to the oil. The mixture was cooked at a temperature set at 85° C. for 7 min at speed set at 4 (2000 rpm). At the end of each minute, the speed was set to “Turbo” (12,000 rpm) for 3 seconds to thoroughly mix the emulsion as well as to prevent burning and sticking of the emulsion to the wall of the cooker. The hot emulsion was poured into plastic screwed cap pottles, inverted then stored at 4° C. The final pH of the spread was 5.75±0.05.

The textures of the stored spread samples were measured at 1 week of age.

Composition of the Emulsion

The spreads had a nominal composition of 51.0% moisture, 31.4% fat, 10.0% protein, 5.9% lactose and remainder 1.7% other.

Texture of Processed Cheese Spread Samples

The texture of a processed cheese spread prepared by using the ingredients of this invention was measured and compared with a control prepared using a standard MPC70 ingredient. Texture was assessed by measuring the elastic modulus, G′ of a sample of the resulting product. The elastic modulus was obtained at 0.1 Hz, strain of 0.005 at 20° C. using a texture analyser TA AR2000 rheometer (TA Instruments—Waters LLC, New Castle, USA) at 20° C. using the method described by Lee S. K. & Klostermeyer H., Lebensim.-Wiss. U-Technol., 34, 288-292(2001). (A description of elastic modulus is detailed in Ferry (Ferry, J. D., (Ed.), Viscoelastic Properties of Polymers, 3^{rd} edn. New York. John Wiley & Sons. 1980)). Gel firmness observations were replicate determinations taken from different samples taken from the same batch of product (different pottles).

The textures of the spreads measured as G′ are shown in Table 6.

TABLE 6
Comparison of texture of spreads

| | | | Protein | Protein |
|---|---|---|---|---|
| | | Protein | stream 1, | stream 2, |
| | Control | stream 1, | Ca(OH)₂, | NaOH, |
| Proteinate | (ALAPRO | NaOH, | Denatured | Denatured |
| Ingredient | 4700 ™) | Native WP | WP | WP, |
| Texture G′ (Pa) | 199, 177 | 737, 874 | 44, 50 | 164, 145 |

The proteinate ingredients of this invention can be used to prepare processed cheese spreads with a range of textures.

1. A process for producing a protein composition from a dairy stream which comprises the steps:
a) subjecting the dairy stream to conditions which cause the formation of a protein concentrate and serum,
b) separating the protein concentrate and the serum,
c) solubilising the separated protein concentrate in an aqueous solution,
d) combining the solubilised protein concentrate with the separated serum to form the protein composition, and
e) concentrating the protein composition formed in step d.

2. A process as claimed in claim 1, wherein the conditions in step a) comprise adjusting the pH of the dairy stream to a range of 4.5 to 4.8, followed by heating to form a protein concentrate and serum.

3. A process as claimed in claim 1, wherein the conditions in step a) comprise adding an enzyme capable of converting kappa-casein to para-kappa-casein to the dairy stream followed by heating to form a protein concentrate and serum.

4. A process as claimed in claim 1, wherein the step a) comprises dividing the dairy stream aqueous medium containing the milk protein into two portions,
adjusting the pH of one portion to a range of 4.5 to 4.8,
adding an enzyme capable of converting kappa-casein to para-kappa-casein to the other portion, and combining the two portions and heating the combined stream to form a protein concentrate and serum.

5. A process as claimed in claim 1, wherein the dairy stream is skim milk.

6. A process as claimed in claim 1, wherein the dairy stream is pasteurised.

7. A process as claimed in claim 1, wherein the dairy stream undergoes a membrane concentration step.

8. A process as claimed in claim 7, wherein the membrane concentration step is an ultrafiltration step.

9. A process as claimed in claim 2 wherein the pH of the dairy stream is adjusted by the addition of an acid, preferably a food approved acid, more preferably hydrochloric or sulphuric acids.

10. A process as claimed in claim 2 wherein, when the dairy stream contains lactose, the pH of the dairy stream is adjusted by the addition of a starter culture to ferment a portion of the lactose to acid, most commonly lactic acid.

11. A process as claimed in claim 10, wherein the starter culture is any food approved bacteria culture capable of fermenting lactose to form acid.

12. A process as claimed in claim 11 wherein the bacterial culture is of a strain of the genus lactobacillus.

13. A process as claimed in claim 2, wherein the pH is adjusted to about 4.6.

14. A process as claimed in claim 3, wherein the dairy stream is reacted with the kappa casein converting enzyme at a temperature below about 15° C., more preferably at less than 10° C.

15. A process as claimed in claim 14, wherein the kappa casein converting enzyme is chymosin.

16. A process as claimed in claim 14, wherein the kappa casein converting enzyme is rennet, preferably derived from either animal or microbial sources.

17. A process as claimed in claim 1, wherein the protein concentrate and serum are formed by heating to a temperature of between about 25° C. and 70° C., more preferably between 30° C. and 55° C. and most preferably between 40° C. and 50° C.

18. A process as claimed in claim 17, wherein the heating is carried out for a holding time of from 1 to 600 seconds, preferably 5 to 200 seconds, more preferably 10 to 50 seconds.

19. A process as claimed in claim 1, wherein the protein concentrate separated in step b) is washed with water.

20. A process as claimed in claim 1, wherein the protein concentrate separated in step b) is milled.

21. A process as claimed in claim 1, wherein in step c) the protein concentrate is dissolved in an alkaline solution.

22. A process as claimed in claim 21, wherein the alkaline solution contains cations including sodium, potassium, calcium, magnesium or a mixture thereof.

23. A process as claimed in claim 1, wherein the protein levels of the serum separated in step b) are adjusted by addition, removal or modification of the proteins.

24. A process as claimed in claim 1 wherein the serum separated in step b) is concentrated before being combined with the solubilised protein concentrate in step d).

25. A process as claimed in claim 1, wherein the serum separated in step b) is further separated into a protein rich stream and a lactose rich stream.

26. A process as claimed in claim 24 wherein in step d) the concentrated protein solution is mixed with all or part of the protein rich serum stream and all or part of the lactose rich stream to form the protein composition.

27. A process as claimed in claim 1, wherein fat, oil or cream is added to the protein composition formed in step d).

28. A process as claimed in claim 1, wherein the protein composition is homogenised.

29. A process as claimed in claim 1, wherein the protein composition is dried.

30. A process as claimed in claim 1 wherein the protein composition is used in the manufacture of a cheese.

31. (canceled)

32. (canceled)

33. A milk proteinate composition containing both solubilised protein concentrate and recombined serum, which, when concentrated, does not form a gel.

34. The milk proteinate composition of claim 33 having a calcium concentration of from 2,700 mg/kg to 15,000 mg/kg and a sodium concentration of from 11,000 mg/kg to 1,300 mg/kg, both on a dry basis.

35. The milk proteinate composition of claim 33 as a powder.

36. (canceled)

37. A process as claimed in claim 4 wherein the pH is adjusted by the addition of an acid, preferably a food approved acid, more preferably hydrochloric or sulphuric acids.

38. A process as claimed in claim 4 wherein, when the dairy stream contains lactose, the pH is adjusted by the addition of a starter culture to ferment a portion of the lactose to acid, most commonly lactic acid.

39. A process as claimed in claim 4, wherein the other portion of the dairy stream is reacted with the kappa casein converting enzyme at a temperature below about 15° C., more preferably at less than 10° C.
